(19) United States
(12) Patent Application Publication
(10) Pub. No.: US 2011/0256454 A1
(43) Pub. Date: Oct. 20, 2011

(54) Masterbatch of carbon-based conductive fillers for liquid formulations, especially in Li-Ion batterries

(75) Inventors: Serge Nicolas, Lons (FR); Alexander Korzhenko, Pau (FR); Amelie Merceron, Aussevielle (FR); Mickael Havel, Buros (FR); Yvan Lecomte, Arthez de Bearn (FR)

(73) Assignee: Arkema France, Colombes (FR)

(21) Appl. No.: 13/052,276

(22) Filed: Mar. 21, 2011

(30) Foreign Application Priority Data
Mar. 23, 2010 (FR) 10.52091
Sep. 23, 2010 (FR) 10.57669

(51) Int. Cl. H01M 4/62; H01M 4/1393; H01B 1/24; B82Y 99/00

(52) U.S. Cl. 429/232; 252/511; 427/58; 29/623.5; 977/948

(57) ABSTRACT

The present invention relates to a masterbatch in agglomerated solid form comprising:
a) carbon nanofibers and/or nanotubes and/or carbon black, the content of which is between 15 wt % and 40 wt %, preferably between 20 wt % and 35 wt %, relative to the total weight of the masterbatch;
b) at least one solvent;
c) at least one polymer binder, which represents from 1 wt % to 40 wt %, preferably from 2 wt % to 30 wt % relative to the total weight of the masterbatch.

The present invention also relates to a concentrated masterbatch, characterized in that it is obtained by eliminating all or part of the solvent from the masterbatch described previously.

It also relates to a process for preparing said masterbatches and to the uses of the latter, especially in the manufacture of an electrode or of a composite material for an electrode.

The present invention relates to a masterbatch containing carbon-based conductive fillers, such as carbon nanotubes, and also to its preparation method and to the use of this masterbatch for the manufacture of components of Li-ion batteries and of supercapacitors, and more generally for integrating carbon nanotubes into aqueous-based or organic-based liquid formulations.

An Li-ion battery comprises at least one negative electrode or anode coupled to a current collector made of copper, one positive electrode or cathode coupled to a current collector made of aluminum, a separator, and an electrolyte. The electrolyte consists of a lithium salt, generally lithium hexafluorophosphate, mixed with a solvent, which is a mixture of organic carbonates chosen to optimize the transport and the dissociation of the ions. A high dielectric constant is favorable to ion dissociation, and therefore to the number of ions available in a given volume, whereas a low viscosity is favorable to ion diffusion which, among other parameters, plays an essential role in the charge and discharge rates of the electrochemical system.

An electrode generally comprises at least one current collector on which is deposited a composite material which consists of: a material that is said to be active because it has an electrochemical activity with respect to lithium, a polymer, which acts as binder and is generally a vinylidene fluoride copolymer for the positive electrode and aqueous-based binders, of carboxymethyl cellulose or styrene-butadiene latex type, for the negative electrode, plus an electronically conductive additive, which is generally Super P carbon black or acetylene black.

During charging, lithium is inserted into the negative electrode (anode) active material and its concentration in the solvent is kept constant by an equivalent amount being extracted from the positive electrode (cathode) active material. Insertion into the negative electrode results in lithium reduction and therefore it is necessary to supply, via an external circuit, electrons to this electrode going from the positive electrode. During discharging the opposite reactions take place.

It has been demonstrated in preceding studies that replacing the carbon black or the acetylene black with carbon nanotubes (CNTs), or else adding CNTs to such conductive additives, exhibits many advantages: increase of the electrical conductivity, better integration around particles of active material, good intrinsic mechanical properties, ability to form an electrical network that is better connected in the bulk of the electrode and between the metallic collector and the active material, good capacity retention during cycling in the electrode composite, etc.

By way of example, K. Sheem et al. (J. Power Sources, 158, (2006), 1425) show that CNTs at 5 wt % relative to the electrode materials may provide a better cycling performance than Super P carbon black, with LiCoO₂ as cathode material. As regards W. Guoping et al. (Solid State Ionics 179 (2008) 263-268), they report a better capacity performance during cycling and as a function of the current density of an LiCoO₂ cathode when the electrode contains 3 wt % of CNTs instead of 3 wt % of acetylene black or nanofibers.

However, the introduction of carbon nanotubes into the formulations of the materials forming the electrodes all the same still raises some negative points that need to be improved.

When the dispersion of the CNTs is carried out directly in the liquid formulations (especially in organic solvent bases), a high viscosification of the dispersion and a low stability of such a dispersion are witnessed. To overcome this drawback, use is made of ball mixers and high-shear mills and mixers. However, the content of CNTs capable of being introduced into the liquid formulations remains limited to 1-2%. These difficulties limit the practical use of CNTs in the formulations of the materials constituting the electrodes owing to the aggregation of the CNTs due to their highly entangled structure.

Moreover, from a toxicological point of view, the CNTs are generally in the form of agglomerated powder grains, the average dimensions of which are of the order of a few hundreds of microns. The differences in dimensions, in form, and in physical properties mean that the toxicological properties of the CNT powders are not yet fully known. It would therefore be preferable to be able to work with CNTs in agglomerated solid form of macroscopic size.

In this respect, document US 2004/0160156 describes a method of preparing an electrode for a battery from a masterbatch, in the form of granules composed of CNTs and of a resin that acts as binder, to which a suspension of electrode active material is added.

In this document, the resin is present in a large amount within the masterbatch, since the CNTs are present in proportions ranging from 5 to 20 parts by weight per 100 parts by weight of resin. This high binder content is problematic for the compounder of electrode materials who wishes to use “universal” masterbatches in predefined compositions without generating formulation constraints, in particular without limiting the choice of the binder used in these compositions.

This is why it would be advantageous for the compounder to have available ready-to-use masterbatches that can be used directly in a wide variety of formulations for the manufacture of electrodes (varnishes, inks, films, etc.) with a view to increasing their electrical conductivity.

The Applicant has discovered that this requirement could be met by preparing a masterbatch of carbon nanotubes in agglomerated solid form containing a binder content of the same order of magnitude as that of the CNTs. The Applicant has also developed a process for manufacturing this masterbatch, which allows an efficient and homogeneous dispersion of the carbon nanotubes within the masterbatch and around the electrode active material. Finally, it has become apparent to the Applicant that this masterbatch could be used for integrating carbon nanotubes into other liquid formulations.

Document EP 2 081 244 describes a composition based on carbon nanotubes, a solvent and a binder, but which is not in an agglomerated solid form since it is intended to be sprayed over a layer of electrode active material, and not to be used as a masterbatch to be diluted in an electrode composition.

It has furthermore become apparent to the Applicant that this invention could also be applied to carbon-based conductive fillers other than nanotubes and in particular to carbon nanofibers and to carbon black, which are also capable of posing safety problems owing to their pulverulent nature and their ability to generate fines in the production plants.

Carbon nanofibers are, like carbon nanotubes, nanofilaments produced by chemical vapor deposition (or CVD) starting from a carbon-based source which is decomposed over a catalyst comprising a transition metal (Fe, Ni, Co, Cu), in the presence of hydrogen, at temperatures of 500 to 1200° C. However, these two carbon-based fillers differ due to their structure (I. MARTIN-GULLON et al., Carbon, 44 (2006), 1572-1580). Specifically, the carbon nanotubes consist of one or more sheets of graphene rolled up concentrically about the axis of the fiber to form a cylinder having a diameter of 10 to 100 nm. Conversely, carbon nanofibers are made up of relatively organized graphitic regions (or turbostratic stacks), the planes of which are inclined at various angles to the axis of the fiber. These stacks may take the form of platelets, herringbones or stacked cups in order to form structures that have a diameter ranging generally from 100 nm to 500 nm or even more. Furthermore, carbon black is a colloidal carbon-based material, manufactured industrially by incomplete combustion of heavy petroleum products, which is in the form of spheres of carbon and aggregates of these spheres, the dimensions of which are generally between 10 and 1000 nm.

Japanese patent document JP 10 255844 describes the manufacture of a battery, the positive electrode of which is produced by means of a masterbatch containing a conductive material chosen from furnace black, acetylene black and graphite.

Document FR 1 307 346 describes the preparation of masterbatches containing rubber, carbon black and optionally a plasticizer or an extender oil. This masterbatch is in liquid form and contains only a small content of carbon black relative to the total weight of the masterbatch. It is only used after the solvent has been evaporated.

The present invention consequently relates, according to a first aspect, to a masterbatch in agglomerated solid form comprising:
a) carbon nanofibers and/or nanotubes and/or carbon black, the content of which is between 15 wt % and 40 wt %, preferably between 20 wt % and 35 wt %, relative to the total weight of the masterbatch;
b) at least one solvent;
c) at least one polymer binder, which represents from 1 wt % to 40 wt %, preferably from 2 wt % to 30 wt % relative to the total weight of the masterbatch.

In the remainder of this description, for the sake of simplicity, the expression “carbon-based conductive filler” denotes a filler comprising at least one element from the group formed of carbon nanotubes and nanofibers and carbon black, or a mixture of these in any proportions.

The binder/carbon-based conductive filler weight ratio is preferably less than 2.

The carbon nanotubes that are incorporated into the composition of the masterbatch according to the invention may be of single-walled, double-walled or multiwalled type. The double-walled nanotubes may especially be prepared as described by FLAHAUT at al. in Chem. Com. (2003), 1442. The multiwalled nanotubes may, for their part, be prepared as described in document WO 03/02456.

Nanotubes customarily have an average diameter ranging from 0.1 to 100 nm, preferably from 0.4 to 50 nm and, better still, from 1 to 30 nm, or even from 10 to 15 nm, and advantageously a length from 0.1 to 10 μm. Their length/diameter ratio is preferably greater than 10 and usually greater than 100. Their specific surface area is for example between 100 and 300 m²/g, advantageously between 200 and 300 m²/g, and their bulk density may especially be between 0.05 and 0.5 g/cm³ and more preferably between 0.1 and 0.2 g/cm³. The multiwalled nanotubes may for example comprise from 5 to 15 sheets (or walls) and more preferably from 7 to 10 sheets. These nanotubes may or may not be treated.

An example of raw carbon nanotubes is in particular commercially available from the company Arkema under the trade name Graphistrength® C100.

These nanotubes may be purified and/or treated (for example oxidized) and/or milled and/or functionalized before they are used in the process according to the invention.

The milling of the nanotubes may especially be carried out cold or hot using known processing techniques in equipment such as ball mills, hammer mills, grinding mills, knife or blade mills, gas jet mills or any other milling system that can reduce the size of the entangled network of nanotubes. It is preferable for this milling step to be carried out using a gas jet milling technique, in particular in an air jet mill.

The raw or milled nanotubes may be purified by washing with a solution of sulfuric acid, so as to strip them of any residual metallic or mineral impurities, such as iron for example, resulting from their preparation process. The weight ratio of nanotubes to sulfuric acid may especially be between 1/2 and 1/3. The purifying operation may furthermore be carried out at a temperature ranging from 90 to 120° C., for example for a time of 5 to 10 hours. This operation may advantageously be followed by steps in which the purified nanotubes are rinsed with water and dried. Another way of purifying the nanotubes consists in subjecting them to a heat treatment at high temperature, typically above 1000° C.

Advantageously, the oxidation of the nanotubes is carried out by bringing them into contact with a sodium hypochlorite solution containing 0.5 to 15% NaOCl by weight and preferably 1 to 10% NaOCl by weight, for example in a nanotube/sodium hypochlorite weight ratio ranging from 1/0.1 to 1/1. Advantageously, the oxidation is carried out at a temperature below 60° C. and preferably at room temperature, for a time ranging from a few minutes to 24 hours. This oxidation operation may advantageously be followed by steps in which the oxidized nanotubes are filtered and/or suction-filtered, washed and dried.

The nanotubes may be functionalized by grafting reactive units such as vinyl monomers to the surface of the nanotubes. The constituent material of the nanotubes is used as a radical polymerization initiator after having been subjected to a heat treatment at more than 900° C., in an anhydrous, oxygen-free medium, which is intended to remove the oxygenated groups from its surface. It is thus possible to polymerize methyl methacrylate or hydroxyethyl methacrylate at the surface of carbon nanotubes with a view to facilitating, in particular, their dispersion in PVDF or polyamides.

Use is preferably made, in the present invention, of raw, optionally milled, nanotubes, that is to say of nanotubes that are neither oxidized nor purified nor functionalized and that have not undergone any other chemical and/or heat treatment.

Furthermore, it is preferred to use carbon nanofibers having a diameter of 100 to 200 nm, for example of around 150 nm (VGCF® from SHOWA DENKO), and advantageously a length of 100 to 200 μm.

The polymer binder used in the present invention is advantageously chosen from the group consisting of polysaccharides, modified polysaccharides, polyethers, polyesters, acrylic polymers, polycarbonates, polyimines, polyamides, polyacrylamides, polyurethanes, polyepoxides, polyphosphazenes, polysulfones, halogenated polymers, natural rubbers, functionalized or unfunctionalized elastomers, especially elastomers based on styrene, butadiene and/or isoprene, and mixtures thereof. These polymer binders may be used in solid form or in the form of a liquid solution or dispersion (latex type) or else in the form of a supercritical solution. It is preferred to use a polymer binder in the form of a solution.

Preferably, for a use in the manufacture of an electrode, the polymer binder is chosen from the group consisting of halogenated polymers and more preferably still from fluoropolymers defined, in particular, in the following manner:

(i) those comprising at least 50 mol % of at least one monomer of formula (I):

CFX₁═CX₂X₃ (I)

where X₁, X₂ and X₃ independently denote a hydrogen atom or halogen atom (in particular a fluorine or chlorine atom), such as polyvinylidene fluoride (PVDF), preferably in a form, polytrifluoroethylene (PVF3), polytetrafluoroethylene (PTFE), copolymers of vinylidene fluoride with either hexafluoropropylene (HFP), or trifluoroethylene (VF3), or tetrafluoroethylene (TFE), or chlorotrifluoroethylene (CTFE), fluoroethylene/propylene (FEP) copolymers, copolymers of ethylene with either fluoroethylene/propylene (FEP), or tetrafluoroethylene (TFE), or chlorotrifluoroethylene (CTFE);

(ii) those comprising at least 50 mol % of at least one monomer of formula (II):

R—O—CH—CH₂ (II)

where R denotes a perhalogenated (in particular perfluorinated) alkyl radical, such as perfluoropropyl vinyl ether (PPVE), perfluoroethyl vinyl ether (PEVE) and copolymers of ethylene with perfluoromethyl vinyl ether (PMVE).

When it is intended to be integrated into formulations in an aqueous medium, the masterbatch according to the invention advantageously contains, as binder, at least one modified polysaccharide such as a modified cellulose, in particular carboxymethyl cellulose. This may be in the form of an aqueous solution or in solid form or else in the form of a liquid dispersion.

The solvent used in the present invention may be an organic solvent or water or mixtures thereof in any proportions. Among the organic solvents mention may be made of N-methylpyrrolidone (NMP), dimethyl sulfoxide (DMSO), dimethylformamide (DMF), ketones, acetates, furans, alkyl carbonates, alcohols and mixtures thereof. NMP, DMSO and DMF are preferred for use in the present invention.

The amount of solvent present in the masterbatch ranges from 20 to 84 wt %, more preferably from 50 to 75 wt % and, better still, from 60 to 75 wt % relative to the total weight of the masterbatch, as long as all of the constituents of the masterbatch represent 100%.

The masterbatch according to the invention thus advantageously contains: from 20 to 30 wt % of carbon nanotubes, from 2 to 5 wt % of PVDF resin and from 65 to 75 wt % of NMP. One example of such a masterbatch is that containing: 25 wt % of CNT, 4 wt % of PVDF and 71 wt % of NMP, available in the form of granules, which is especially sold by the company Arkema under the trade name CM19-25.

According to a second aspect, the invention relates to a process for preparing said masterbatch comprising:
(i) dissolving a powder of the polymer binder in the solvent to form a solution;
(ii) mixing said solution with carbon nanofibers and/or nanotubes and/or carbon black, in a compounding device;
(iii) kneading said mixture.

The masterbatch is thus prepared in three successive steps.

One embodiment of step i) consists in dissolving the powder of the polymer binder in the solvent by stirring the solution thus formed over a time period of between 30 minutes and 2 hours at a temperature between 0° C. and 100° C., preferably between 20° C. and 60° C.

One embodiment of step ii) consists in introducing, into a kneader or compounding device, the carbon-based conductive fillers and the polymer solution resulting from step i) at an introduction temperature of between 10° C. and 90° C.

The carbon-based conductive fillers and the polymer solution may be mixed before being introduced into the kneader. In this case, the carbon-based conductive fillers and the polymer solution are introduced simultaneously into the same feed zone of the kneader, in particular BUSS® type kneader. In the case where the carbon-based conductive fillers are mixed with the polymer solution after being introduced into the kneader, the carbon-based conductive fillers and the polymer solution are introduced successively into the same feed zone of the kneader or else into two separate feed zones.

One embodiment of step iii) consists in kneading the mixture via a compounding route, advantageously using a co-rotating or counter-rotating twin-screw extruder or using a co-kneader (in particular of BUSS® type) comprising a rotor provided with flights designed to cooperate with teeth mounted on a stator. The kneading may be carried out at a temperature preferably between 20° C. and 90° C.

Compounding devices are well known to those skilled in the art and generally include feed means, especially at least one hopper for pulverulent materials and/or at least one injection pump for liquid materials; high-shear kneading means, for example a co-rotating or counter-rotating twin-screw extruder or a co-kneader, usually comprising a feed screw placed in a heated barrel (or tube); an output head, which gives the extrudate its shape; and means for cooling the extrudate, either by air cooling or by circulation of water. The extrudate is generally in the form of rods continuously exiting the device and able to be cut or formed into granules. However, other forms may be obtained by fitting a die of desired shape on the output die.

Examples of co-kneaders that can be used according to the invention are BUSS® MDK 46 co-kneaders and those of the BUSS® MKS or MX series, sold by the company BUSS AG, which all consist of a screw shaft provided with flights, placed in a heated barrel optionally made up of several parts, and the internal wall of which is provided with kneading teeth designed to cooperate with the flights so as to shear the kneaded material. The shaft is rotated, and given an oscillatory movement in the axial direction, by a motor. These co-kneaders may be equipped with a granulation system, for example fitted at the exit orifice of said co-kneaders, which may consist of an extrusion screw.

The co-kneaders that can be used according to the invention preferably have an L/D screw ratio ranging from 7 to 22, for example from 10 to 20, whereas co-rotating extruders advantageously have an L/D ratio ranging from 15 to 56, for example from 20 to 50.

The carbon-based conductive fillers are thus dispersed efficiently and homogeneously. In addition, it is possible to modify the surface of the carbon-based conductive fillers, in particular of the CNTs, during the compounding step with additives that promote the integration of these fillers into the liquid formulations.

The masterbatch thus obtained may then optionally be dried, by any known process (ventilated or vacuum oven, infrared, induction, microwave, etc.), for the purpose, in particular, of removing all or part of the solvent and of thus obtaining a masterbatch that is more concentrated in carbon-based conductive fillers, containing for example from 20 to 98 wt % of these fillers, preferably from 25 to 60%, or even from 40 to 60% in the case of an aqueous solvent or from 60 to 95% in the case of an organic solvent, and advantageously having a binder/carbon-based filler weight ratio of less than 2, or even of less than 1.6. This embodiment is more particularly suitable for the masterbatches intended to be introduced into liquid formulations.

Therefore, the present invention also relates to a concentrated masterbatch, characterized in that it is obtained by removing all or part of the solvent from the masterbatch described previously.

As a variant, the masterbatch may be used as is, in the form of granules or other agglomerated solid forms, the conditioning of which facilitates the storage thereof.

The masterbatch obtained at the end of this process and that is optionally concentrated may be used for the manufacture of electrodes for Li-ion batteries or supercapacitors, for the manufacture of paints, inks, adhesives, primary coatings, ceramic composites and concretes, thermosetting composites, and compositions for sizing fibers or for treating textiles, in particular.

Therefore, another subject of the present invention is the use of the (optionally concentrated) masterbatch as described previously for preparing liquid formulations.

According to one particular aspect, the invention also relates to a process for preparing an electrode, comprising the following steps:
a) the preparation of a mixture by dispersion in a dispersion solvent of the (optionally concentrated) masterbatch described previously, containing at least a first binder and optionally at least a first solvent;
b) the preparation of a solution by dissolving at least a second polymer binder in at least a second solvent;
c) the addition of an electrode active material to said solution;
d) the mixing of the products resulting from steps a) and c);
e) the deposition of the composition thus obtained on a substrate in order to form a film;
f) the drying of said film.

It is clearly understood that the above process may comprise other preliminary, intermediate or subsequent steps, as long as they do not adversely affect the production of the desired electrode film. Thus, an intermediate step may in particular be provided between steps d) and e), comprising the addition of a portion of the second binder, for example in solution in the first solvent, by means, in particular, of a flocculator type stirrer.

The expression “first binder” is understood to mean the binder used during the preparation of the masterbatch described previously. The expression “first solvent” is understood to mean the solvent used during the preparation of the masterbatch described previously.

During step (a), the masterbatch is dispersed in a dispersion solvent which may correspond to the first solvent or be different therefrom. The fact that the masterbatch is in agglomerated solid form comprising a high solvent content makes it possible to facilitate the dispersion of the carbon-based conductive fillers, in particular CNTs, in the medium. Similarly, when the masterbatch is in dried form, the high porosity of the “dry” solid makes it possible to facilitate the wetting of the solid and therefore the dispersion of the carbon-based conductive fillers in the medium.

During this step (a), the masterbatch containing the carbon-based conductive fillers is dispersed using a suitable mixer which may be either a propeller mixer, with a marine propeller type spindle, or a mixer-disperser of “flocculator” type or of “rotor-stator” type.

The flocculator system corresponds to a stirrer having a spindle that consists of a disk provided with prongs perpendicular to the plane of the disk, which makes it possible to obtain a high local shear.

The rotor-stator system generally comprises a rotor driven by a motor and provided with fluid guiding systems perpendicular to the rotor axis, such as paddles or blades placed approximately radially, or a flat disk provided with peripheral teeth, said rotor being optionally provided with a ring gear, and a stator arranged concentrically with respect to the rotor, and at a short distance to the outside of the latter, said stator being equipped, over at least a portion of its circumference, with openings provided for example in a grid or defining between them one or more rows of teeth, which are suitable for passage of the fluid drawn into the rotor and ejected by the guiding systems towards said openings. One or more of the aforementioned teeth may be provided with sharp edges. The fluid is thus subjected to a high shear, both in the gap between the rotor and the stator and through the openings provided in the stator.

One such rotor-stator system is in particular sold by the company SILVERSON under the trade name Silverson® L4RT. Another type of rotor-stator system is sold by the company IKA-WERKE under the trade name Ultra-Turrax®. Yet other rotor-stator systems consist of colloid mills, and high-shear mixers of the rotor-stator type, such as the machines sold by the company IKA-WERKE or by the company ADMIX.

According to the invention, the speed of the rotor is preferably set at least 1000 rpm and preferably at least 3000 rpm or even at least 5000 rpm. Furthermore, the width of the gap between the rotor and the stator is preferably less than 1 mm, preferably less than 200 μm, more preferably less than 100 μm and better still less than 50 μm or even less than 40 μm. Moreover, the rotor-stator system used according to the invention advantageously applies a shear rate ranging from 1000 to 10⁹ s⁻¹.

Step (b) consists in dissolving a polymer binder, which may correspond to the first binder used in the preparation of the masterbatch or be different therefrom, in a solvent which may correspond to the first solvent used in the preparation of the masterbatch or to the dispersion solvent or be different therefrom. During this step, stirrers of “flocculator” type are preferred. It is followed by the addition of an electrode active material, which may be dispersed, while being stirred, in the form of powder, in the mixture resulting from step (b).

The electrode active material introduced during step (c) is chosen from the group consisting of:

i) transition metal oxides of spinel structure of LiM₂O₄ type, where M represents a metal atom containing at least one of the metal atoms chosen from the group formed by Mn, Fe, Co, Ni, Cu, Mg, Zn, V, Ca, Sr, Ba, Ti, Al, Si, B and Mo, said oxides preferably containing at least one Mn and/or Ni atom;

ii) transition metal oxides of lamellar structure of LiMO₂ type, where M represents a metal atom containing at least one of the metal atoms chosen from the group formed by Mn, Fe, Co, Ni, Cu, Mg, Zn, V, Ca, Sr, Ba, Ti, Al, Si, B and Mo, said oxides preferably containing at least one of the atoms chosen from the group formed by Mn, Co and Ni;

iii) oxides having polyanionic frameworks of LiM_{y}(XO_{z})ₙ type where:
M represents a metal atom containing at least one of the metal atoms chosen from the group formed by Mn, Fe, Co, Ni, Cu, Mg, Zn, V, Ca, Sr, Ba, Ti, Al, Si, B and Mo, and
X represents one of the atoms chosen from the group formed by P, Si, Ge, S and As, preferably LiFePO₄,

iv) vanadium-based oxides,

v) graphite,

vi) titanates.

The electrode active materials i) to iv) are more suitable for the preparation of cathodes, whereas the electrode active materials v) and vi) are more suitable for the preparation of anodes.

The product resulting from step (c) is mixed with that resulting from step (a) (step (d)), optionally after mixing using the flocculator. The mixing may be carried out using any mechanical means as long as they make it possible to obtain a homogeneous dispersion. The expression “homogeneous dispersion” is preferably understood, within the meaning of the present invention, to mean that the mixture of the dispersion resulting from step (a) with the dispersion resulting from step (c), observed using an electronic microscope after 30 minutes of treatment, or even after 20 minutes of treatment, does not reveal (in the case of CNTs) aggregates having a size greater than 50 μm, preferably greater than 30 μm, or even greater than 20 μm, measured along their longer dimension.

It is preferred according to the invention that the mixing of step d) is carried out using a mixer of “flocculator” type or using “rotor-stator” systems of Silverson® type and/or using ball mills and/or planetary mills.

The proportions of the various compounds used in the above process are adjusted so that the film obtained advantageously contains from 1 to 2 wt % of carbon-based conductive fillers.

By virtue of the process according to the invention, it is especially possible to distribute the carbon nanofibers and nanotubes so that they form a mesh around the particles of active material and thus play both a conductive additive role and also a mechanical support role, important for accommodating the volume changes during charge-discharge steps. On the one hand, they ensure the distribution of electrons to the particles of active material and, on the other hand, owing to their length and their flexibility, they form electrical bridges between the particles of active material which shift following their change in volume. When they are used alone, standard conductive additives (SP carbon, acetylene black and graphite), with their relatively low aspect ratio, are less effective for ensuring the maintenance, during the cycling, of the transport of electrons from the current collector. Indeed, with conductive additives of this type, the electrical pathways are formed by the juxtaposition of grains and the contacts between them are easily broken following the volume expansion of the particles of active material.

During step (e), the film obtained from the suspension resulting from step (d) may be deposited on a substrate by any conventional means, for example by extrusion, by tape casting, by coating or by spray drying followed by a drying step (step (f)).

The substrate may in particular be a current collector. An electrode is thus obtained.

Another subject of the invention consequently consists of a composite electrode, anode or cathode (in particular a cathode), capable of being obtained as described above, from the masterbatch according to the invention.

According to another aspect, the invention also relates to a process for preparing a composite active material for an electrode, comprising the following steps:

a) the provision of an electrode active material in the form of an aqueous solution or dispersion;

b) the addition and mixing of the (optionally concentrated) masterbatch described previously, said masterbatch containing a water-soluble or water-dispersible binder, to the aqueous solution or dispersion obtained in step (a);

c) the suction-filtering and drying of the mixture obtained in step (b).

It is clearly understood that the above process may comprise other preliminary, intermediate or subsequent steps, as long as they do not adversely affect the production of the desired composite material for an electrode. Thus, one or more intermediate step(s) may in particular be provided between steps (a) and (b) and/or between steps (b) and (c), comprising washing, filtration or any other step of purifying the mixture.

One electrode active material defined above is, for example, that described in patent document FR 2 865 576.

Such a process is characterized by the reaction, under a controlled atmosphere, of a precursor of the electrode active material, for example Li₂HPO₄, with an iron (III) complex. The electrode active material formed is then in aqueous solution.

According to one embodiment, the electrode active material then obtained may be used directly in step (a) of the above process.

According to another embodiment, this electrode active material may be recovered by filtration or sedimentation, and optionally washed then dried. Step (a) of the above process may then consist of the redispersion or resolubilization of this electrode active material. The redispersion or resolubilization may be carried out using a suitable mixer which may be either a propeller mixer, with a marine propeller type spindle, combined with scrapers along the walls of the container, or a mixer-disperser of “flocculator” type or of “rotor-stator” type.

Preferably, the electrode active material in the form of an aqueous solution or dispersion is provided in step (a) in a filter, advantageously equipped with a stirrer.

During step (b), the masterbatch containing the carbon-based conductive fillers is added and mixed with the aqueous solution or dispersion of electrode active material using a suitable mixer which may be either a propeller mixer, with a marine propeller type spindle, combined with scrapers along the walls of the container, or a mixer-disperser of “flocculator” type or of “rotor-stator” type. Preferably, it is a “flocculator” type mixer, as described above. This method of mixing makes it possible, unlike milling processes, not to break the carbon-based conductive fillers too much, in particular when these are carbon nanotubes. The binder contained in the masterbatch is water-soluble or water-dispersible. Advantageously, said binder comprises at least one modified polysaccharide such as a modified cellulose, in particular carboxymethyl cellulose.

The composite active material for an electrode is recovered after having been suction-filtered and dried during step (c). The drying consists in removing all or part of the water, preferably all of the water, so as to obtain an anhydrous material. The drying is preferably carried out according to the conventional heating techniques or by spray drying (atomization).

This process for preparing a composite active material for an electrode has the advantage of allowing the addition of the masterbatch comprising the carbon-based conductive fillers during the preparation of the electrode active material, which is in an aqueous medium during its synthesis, and therefore of simplifying the process.

As a variant, step (b) of the process for preparing a composite active material for an electrode described, above may be replaced by a step (b′) consisting:
in preparing a mixture by dispersion in water of the (optionally concentrated) masterbatch described previously, said masterbatch containing a water-soluble or water-dispersible binder, and
in adding and mixing said solubilized or dispersed masterbatch to the aqueous solution or dispersion of the electrode active material obtained in step (a).

The proportions of the various compounds used in the various variants of the above process are adjusted so that the composite active material for an electrode obtained advantageously contains from 1 to 5 wt % of carbon-based conductive fillers.

The composite active material for an electrode obtained, comprising an electrode active material and a carbon-based conductive filler, has a morphology suitable for the manufacture of electrodes. Moreover, since the material has not been subjected to mechanical milling, the particle size of the active material has not been modified. In addition, the electrode manufacturing process is simplified.

Another subject of the invention consequently consists of a composite active material for an electrode, anode or cathode (in particular a cathode), capable of being obtained as described above, from the masterbatch according to the invention.

Another subject of the invention is the use of the (optionally concentrated) masterbatch as described previously for the preparation of liquid formulations containing carbon-based conductive fillers.

The invention will now be illustrated by the following examples, the purpose of which is not to limit the scope of the invention, defined by the appended claims. In these examples, reference is made to the appended figures, in which:

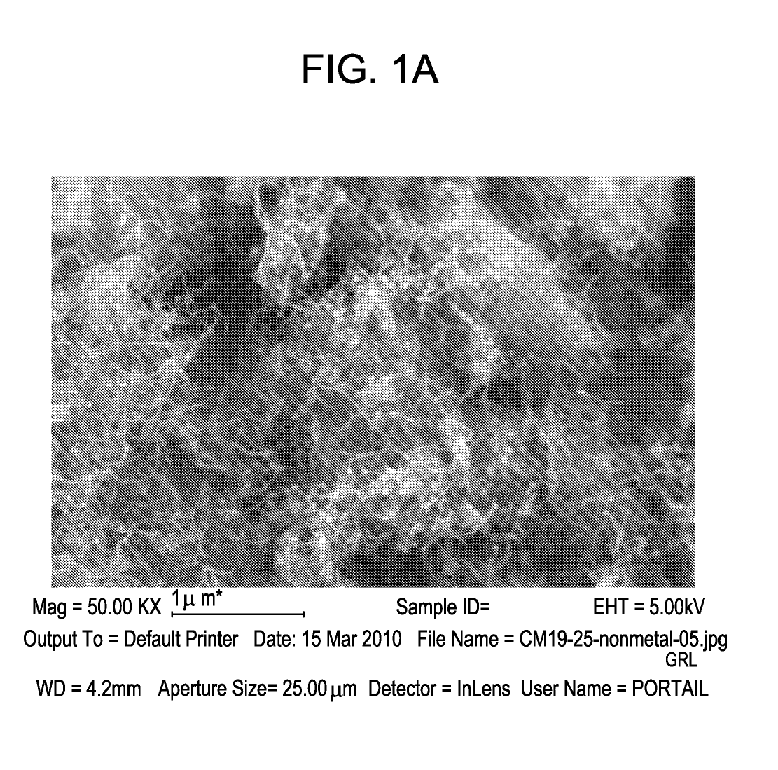

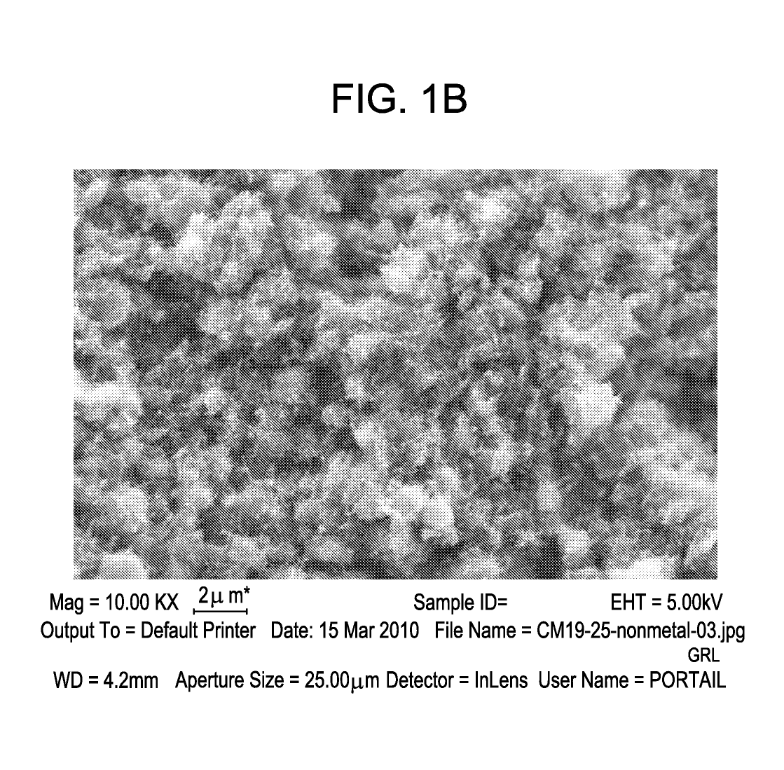

FIGS. 1A and 1B illustrate, using SEM and at two different working distances, the dispersion of the CNTs within the masterbatch obtained in example 1;

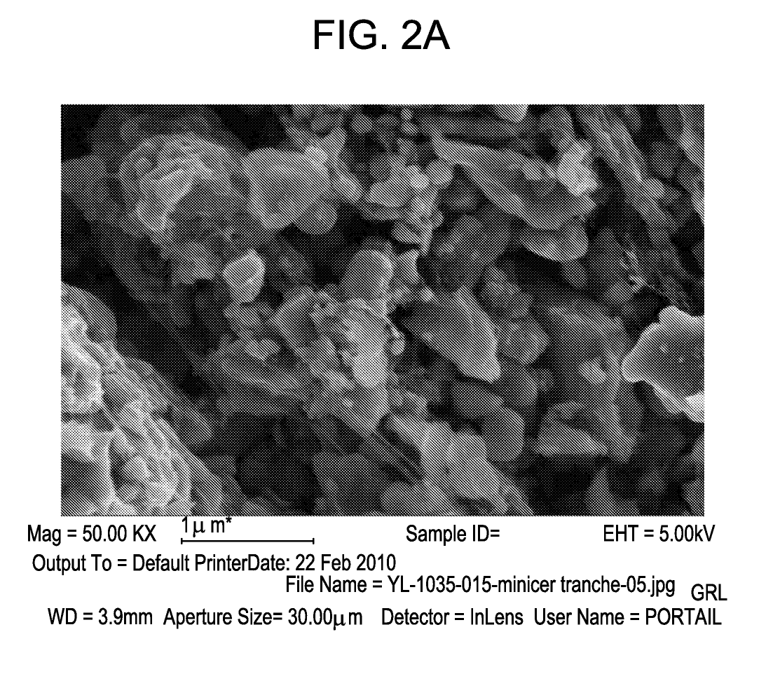

FIGS. 2A and 2B illustrate, using SEM and at two different working distances, the dispersion of the CNTs within the masterbatch obtained in example 2;

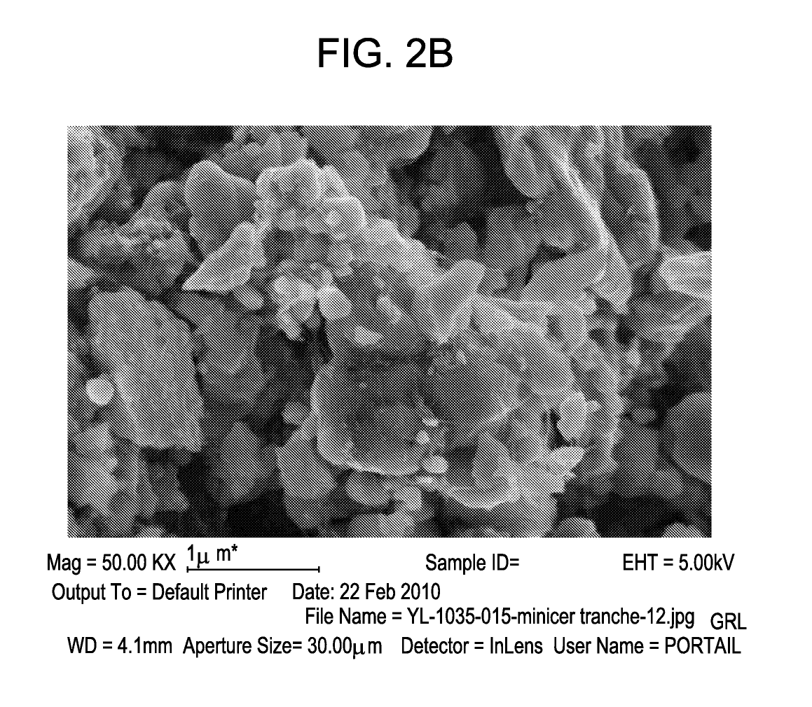

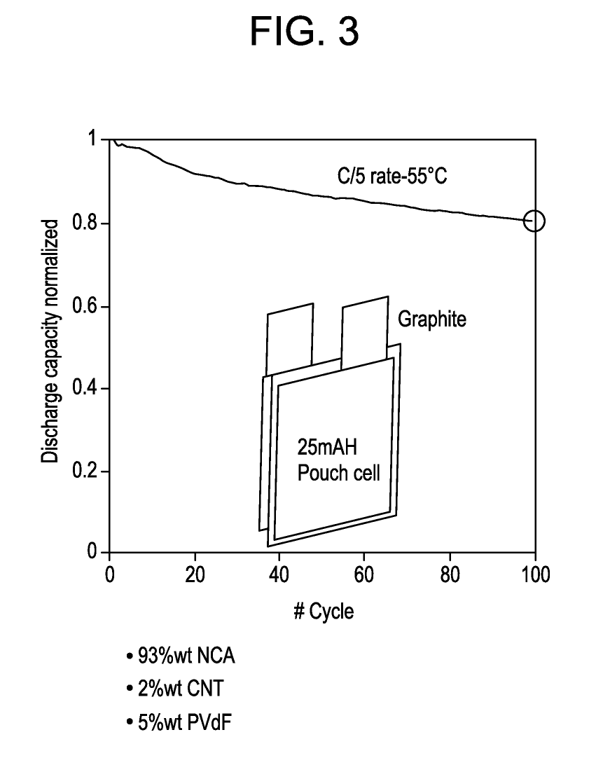

FIG. 3 illustrates the discharge capacity of a battery containing a cathode obtained from the masterbatch according to the invention, as a function of the number of cycles; and

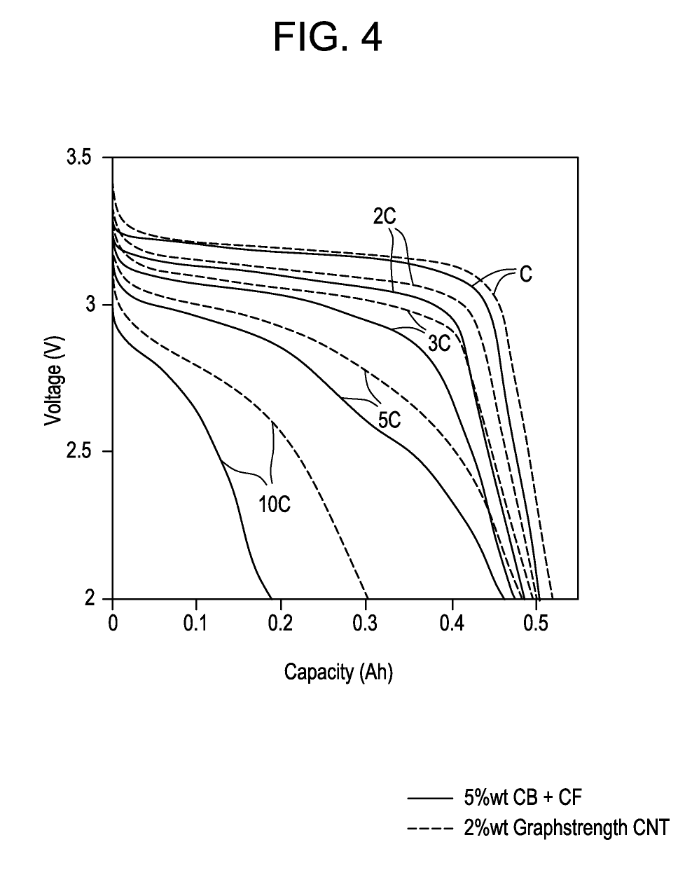

FIG. 4 illustrates the electrochemical performances of an electrode manufactured from the masterbatch according to the invention.

### EXAMPLES

### Example 1

### Preparation of a CNT/PVDF/NMP Masterbatch

A 5 wt % solution of PVDF (Kynar® HSV 900 from ARKEMA) was produced previously by dissolving the powder of the polymer in N-methylpyrrolidone (NMP); the solution was stirred at 50° C. for 60 min.

The CNTs (Graphistrength® C100 from ARKEMA) were introduced into the first feed hopper of a BUSS® MDK 46 (L/D=11) co-kneader, equipped with a discharge extrusion screw and a granulation device. The 5% solution of PVDF (Kynar® HSV 900) in N-methylpyrrolidone (NMP) was injected in liquid form at 80° C. into the first zone of the co-kneader. The temperature settings and the throughput within the co-kneader were the following: zone 1: 80° C., zone 2: 80° C., screw: 60° C., throughput: 15 kg/h.

At the outlet of the die, the masterbatch was cut into granules under dry conditions. The granules were packaged in an airtight container to avoid loss of NMP during storage. The composition of the final masterbatch was the following: 30 wt % of carbon nanotubes, 3.5 wt % of PVDF resin and 66.5 wt % of NMP.

Observations of the dried masterbatch using a scanning electron microscope (SEM) showed that the carbon nanotubes were well dispersed (FIGS. 1A and 1B).

### Example 2

### Use of the CNT/PVDF/NMP Masterbatch for Manufacturing an Electrode

Step a) 20 g of masterbatch granules from example 1 were wetted with 160 g of NMP solvent. After 2 h of static impregnation under ambient conditions, the masterbatch granules were dispersed in the solvent using a Silverson® L4RT mixer at 6000 rpm for 15 minutes. A significant temperature rise was observed during the dispersion operation: the mixture containing the CNTs reached a temperature of 6′7° C. The solution obtained was denoted by “CNT premix”.

Step b) 14.3 g of Kynar® HSV 900 were dissolved in 276 g of NMP solvent using a flocculator-type agitator for 4 hours.

Step c) 279 g of LiFePO₄/C (LFP) (grade P1 from Phostech) powder were dispersed in the Kynar solution; during this step, the LiFePO₄ powder was added gradually while stirring (600 rpm). The suspension obtained was denoted by “LFP premix”.

Step d) In order to obtain a good dispersion of the CNTs around the active LFP material, the two CNT and LFP premixes respectively obtained during steps a) and c) were mixed for 10 minutes using a flocculator agitator at 600 rpm then using a Silverson® L4RT mixer for 15 minutes at 6000 rpm and finally using a Retsch Minicer® ball mill for 30 minutes at 2000 rpm using 0.7 to 0.9 mm ceramic balls. The composition of the ink, as dry matter, was the following: 2% of CNTs; 5% of Kynar® HSV 900 and 93% of LiFePO₄/C with a solids content of 40% in the NMP solvent.

Step e) Using a Sheen film applicator and an adjustable BYK-Gardner® applicator, un film with a thickness of 100 μm was produced on a 25 μm aluminum foil.

Step f) The film produced during step e) was dried at 70° C. for 4 h in a ventilated oven then compressed under 200 bar.

SEM observations showed that the CNTs are well dispersed around the micron-sized particles of LiFePO₄/C (FIGS. 2A and 2B).

### Example 3

### Evaluation of the Electrochemical Performances of an Electrode According to the Invention

The CEA/LITEN laboratories in Grenoble evaluated the electrochemical performances of the positive electrode (cathode) from example 2 by combining it with a graphite anode.

The formulation of the cathode containing 2 wt % of CNTs and 5 wt % of PVDF binder was compared to a standard formulation containing, as conductive additive, 2.5 wt % of Super P carbon black from Timcal (CB) and 2.5 wt % of VGCF carbon fibers from Showa Denko (CF) with 5 wt % of PVDF binder. This standard formulation is obtained by mixing of powders, without going through the preparation, then the dilution, of a masterbatch according to the invention.

On an Li-ion battery having a capacity of 500 mAh, the results obtained under various charge/discharge regimes 1C, 2C, 3C, 5C and 10C (cf. FIG. 4) show that greater capacities are obtained with the battery containing 2 wt % of CNTs in the cathode compared to the standard battery (CB+CF), even more so when the charge/discharge regime is faster (10C).

This example therefore illustrates the better electrochemical performances of the electrode obtained from a masterbatch according to the invention.

### Example 4

### Preparation of a CNT/PVDF/NMP Masterbatch

A 5 wt % solution of PVDF (Kynar® HSV 900 from ARKEMA) was produced previously by dissolving the powder of the polymer in N-methylpyrrolidone (NMP); the solution was stirred at 50° C. for 60 min.

The CNTs (Graphistrength® C100 from ARKEMA) were introduced into the first feed hopper of a BUSS MDK 46 (L/D=11) co-kneader, equipped with a discharge extrusion screw and a granulation device. The 5% solution of PVDF (Kynar® HSV 900) in N-methylpyrrolidone (NMP) was injected in liquid form at 80° C. into the first zone of the co-kneader. The temperature settings and the throughput within the co-kneader were the following: zone 1: 80° C., zone 2: 80° C., screw: 60° C., throughput: 15 kg/h.

At the outlet of the die, the masterbatch was cut into granules under dry conditions. The granules were packaged in an airtight container to avoid loss of NMP during storage. The composition of the final masterbatch was the following: 25 wt % of carbon nanotubes, 4 wt % of PVDF resin and 71 wt % of NMP.

Observations of the dried masterbatch using a scanning electron microscope (SEM) showed that the carbon nanotubes were well dispersed.

### Example 5

### Study of the Stability of the Batteries Obtained from the Masterbatch According to the Invention

The stability of the batteries was studied using, as cathode conductive additive, “raw” CNTs that contain between 2 and 3% of Fe. In order to do this, aging tests at 55° C. were carried out by the CEA/LITEN laboratories on 25 mAh “Pouch cell” batteries comprising a cathode with 93 wt % of the LiNi1/3Co1/3Al1/3O2(NCA) active material with no iron and 2 wt % of “raw” CNTs and 5 wt % of PVDF binder combined with a graphite anode. After 100 cycles at 55° C. with a charge/discharge rate of C/5, the discharge capacity drops by 20% but ICP chemical analysis of the anode does not show an increase in the iron content which remains equal to 3 ppm. There is not therefore any migration of the iron contained in the CNTs of the cathode to the anode (cf. FIG. 3).

### Example 6

### Preparation of a CNT/CMC/Water Masterbatch

A 10 wt % solution of low-weight carboxymethyl cellulose (CMC) (Finnfix® 2 grade) was produced previously by dissolving the powder of the CMC polymer in demineralized water. The solution was stirred at ambient temperature for 60 min.

The CNTs (Graphistrength® 0100 from ARKEMA) were introduced into the first feed hopper of a BUSS® MDK (L/D=11) co-kneader, equipped with a discharge extrusion screw and a granulation device. The 10% solution of CMC in demineralized water was injected in liquid form at 30° C. into the first zone of the co-kneader. The balance of the CMC (22 wt %) was introduced in powder form into the first feed hopper. The temperature settings and the throughput within the co-kneader were the following: zone 1: 30° C., zone 2: 30° C., screw: 30° C., throughput: 15 kg/h.

At the outlet of the die, the masterbatch was cut into granules under dry conditions. The granules were dried in an oven at 80° C. for 6 hours to remove the water.

The composition of the final masterbatch was the following: 40 wt % of carbon nanotubes, 60 wt % of CMC.

The granules were packaged in an airtight container to avoid uptake of water during storage.

### Example 7

### Preparation of a CNT/CMC/Water Masterbatch

A 10 wt % solution of low-weight carboxymethyl cellulose (CMC) (Finnfix® 2 grade) was produced previously by dissolving the powder of the CMC polymer in demineralized water. The solution was stirred at ambient temperature for 60 min.

20 kg of CNTs (Graphistrength® C100 from ARKEMA) were introduced into the first feed hopper of a BUSS® MDK 46 (L/D=11) co-kneader, equipped with a discharge extrusion screw and a granulation device. 61.1 kg of 10% solution of CMC in demineralized water were injected in liquid form at 30° C. into the first zone of the co-kneader. The balance of the CMC (18.9 kg) was introduced in the form of powder into the first feed hopper. The temperature settings and the throughput within the co-kneader were the following: zone 1: 30° C., zone 2: 30° C., screw: 30° C., throughput: 15 kg/h.

The composition of the mixture exiting the die was the following: 20% CNTs/25% CMC and 55% water.

At the outlet of the die, the masterbatch was cut into granules under dry conditions. The granules were dried in an oven at 80° C. for 6 hours to remove the water. The composition of the final masterbatch was the following: 45 wt % of carbon nanotubes, 55 wt % of CMC.

The granules were packaged in an airtight container to avoid uptake of water during storage.

### Example 8

### Dispersion of a CNT/CMC Masterbatch in Water

The dried masterbatch obtained in example 7 is introduced into hot water at 90° C. with gentle stirring so as to obtain a nanotube concentration of 2 wt %. The stirring is continued for 1 hour, which results in a gradual cooling of the dispersion.

Under these conditions, an effective dispersion of the nanotubes in water is obtained.

Such a dispersion may be used for example as an aqueous formulation base for the manufacture of an electrode or of paints.

### Example 9

### Preparation of a Masterbatch Based on Carbon Nanofibers

A 5 wt % solution of PVDF (Kynar® HSV 900 from ARKEMA) was produced by dissolving the powder of the polymer in N-methylpyrrolidone (NMP); the solution was stirred at 50° C. for 60 min.

Carbon nanofibers (VGCF® from SHOWA DENKO) were introduced into the first feed hopper of a BUSS® MDK 46 (L/D=11) co-kneader, equipped with a discharge extrusion screw and a granulation device. The 5% solution of PVDF (Kynar® HSV 900) in N-methylpyrrolidone (NMP) was injected in liquid form at 80° C. into the first zone of the co-kneader. The temperature settings and the throughput within the co-kneader were the following: zone 1: 80° C., zone 2: 80° C., screw: 60° C., throughput: 15 kg/h.

At the outlet of the die, the masterbatch was cut into granules under dry conditions. The granules were packaged in an airtight container to avoid loss of NMP during storage. The composition of the final masterbatch was the following: 25 wt % of nanofibers, 3.75 wt % of PVDF resin and 71.25 wt % of NMP.

### Example 10

### Preparation of a Masterbatch Based on Carbon Black

A 5 wt % solution of PVDF (Kynar® HSV 900 from ARKEMA) was produced by dissolving the powder of the polymer in N-methylpyrrolidone (NMP); the solution was stirred at 50° C. for 60 min.

Carbon black (Super P® from TIMCAL) was introduced into the first feed hopper of a BUSS® MDK 46 (L/D=11) co-kneader, equipped with a discharge extrusion screw and a granulation device. The 5% solution of PVDF (Kynar® HSV 900) in N-methylpyrrolidone (NMP) was injected in liquid form at 80° C. into the first zone of the co-kneader. The temperature settings and the throughput within the co-kneader were the following: zone 1: 80° C., zone 2: 80° C., screw: 60° C., throughput: 15 kg/h.

At the outlet of the die, the masterbatch was cut into granules under dry conditions. The granules were packaged in an airtight container to avoid loss of NMP during storage. The composition of the final masterbatch was the following: 25 wt % of carbon black, 3.75 wt % of PVDF resin and 71.25 wt % of NMP.

### Example 11

### Use of the CNT/CMC Masterbatch for Manufacturing a Conductive Material for Electrodes

Preliminary step) The electrode active material LiFePO₄ was synthesized according to the procedure described in the example 1 of patent FR 848 549. 5 g of the iron (III) nitrilotriacetic complex were introduced into an autoclave reactor in 800 ml of a 0.0256 mol/l solution of lithium hydrogen phosphate, Li₂HPO₄. The reaction was carried out at 200° C. under an autogenous pressure of 20 bar for 2 hours. The mixture was cooled slowly, without stirring, via inertia of the reactor (over around 12 hours). When the reactor had returned to ambient temperature and to atmospheric pressure, the autoclave was opened and the powder recovered was filtered over a Büchner flask. The cake obtained was washed with deionized water, then suction-filtered.

Step a) The suction-filtered cake comprising the electrode active material LiFePO₄ preliminarily prepared was put into suspension in 100 ml of water in the filter using a flocculator-type agitator.

Step b) 134 mg of the CNT/CMC concentrated masterbatch obtained according to example 7 (consisting of 45 wt % of carbon nanotubes and of 55 wt % of CMC) were dispersed in the suspension prepared in step a).

Step c) After suction-filtering the cake, the LiFePO₄/CNT composite active material is dried at 60° C. under vacuum.

An LiFePO₄/CNT conductive material for an electrode containing 3 wt % of CNTs was obtained. It was observed that the CNTs were advantageously well distributed at the surface of the LiFePO₄ particles. CMC is compatible with applications in the batteries.

1. A masterbatch in agglomerated solid form comprising:
a) carbon nanofibers and/or nanotubes and/or carbon black, the content of which is between 15 wt % and 40 wt %, preferably between 20 wt % and 35 wt %, relative to the total weight of the masterbatch;
b) at least one solvent;
c) at least one polymer binder, which represents from 1 wt % to 40 wt %, preferably from 2 wt % to 30 wt % relative to the total weight of the masterbatch.

2. The masterbatch as claimed in claim 1, characterized in that said solvent is an organic solvent, water or mixtures thereof in any proportions.

3. The masterbatch as claimed in claim 2, characterized in that said organic solvent is chosen from N-methylpyrrolidone (NMP), dimethyl sulfoxide (DMSO), dimethylformamide (DMF), ketones, acetates, furans, alkyl carbonates, alcohols and mixtures thereof.

4. The masterbatch as claimed in one of claims 1 to 3, characterized in that said polymer binder is chosen from the group consisting of polysaccharides, modified polysaccharides, polyethers, polyesters, acrylic polymers, polycarbonates, polyimines, polyamides, polyacrylamides, polyurethanes, polyepoxides, polyphosphazenes, polysulfones, halogenated polymers, natural rubbers, functionalized or unfunctionalized elastomers, especially elastomers based on styrene, butadiene and/or isoprene, and mixtures thereof.

5. The masterbatch as claimed in claim 4, characterized in that the polymer binder is chosen from the group consisting of halogenated polymers and preferably from fluoropolymers.

6. The masterbatch as claimed in claim 5, characterized in that the fluoropolymer binder is chosen from:
(i) those comprising at least 50 mol % of at least one monomer of formula (I):
CFX₁═CX₂X₃ (I)
where X_{I}, X₂ and X₃ independently denote a hydrogen atom or halogen atom (in particular a fluorine or chlorine atom), such as polyvinylidene fluoride (PVDF), preferably in a form, polytrifluoroethylene (PVF3), polytetrafluoroethylene (PTFE), copolymers of vinylidene fluoride with either hexafluoropropylene (HFP), or trifluoroethylene (VF3), or tetrafluoroethylene (TFE), or chlorotrifluoroethylene (CTFE), fluoroethylene/propylene (FEP) copolymers, copolymers of ethylene with either fluoroethylene/propylene (FEP), or tetrafluoroethylene (TFE), or chlorotrifluoroethylene (CTFE);
(ii) those comprising at least 50 mol % of at least one monomer of formula (II):
R—O—CH—CH₂ (II)
where R denotes a perhalogenated (in particular perfluorinated) alkyl radical, such as perfluoropropyl vinyl ether (PPVE), perfluoroethyl vinyl ether (PEVE) and copolymers of ethylene with perfluoromethyl vinyl ether (PMVE).

7. The masterbatch as claimed in claim 4, characterized in that the polymer binder is chosen from the group consisting of modified polysaccharides and more preferably from modified celluloses such as carboxymethyl cellulose.

8. The masterbatch as claimed in any one of claims 1 to 6, characterized in that it contains: from 20 to 30 wt % of carbon nanotubes, from 2 to 5 wt % of PVDF resin and from 65 to 75 wt % of NMP.

9. The use of the masterbatch as claimed in one of claims 1 to 8 for manufacturing an electrode.

10. A process for preparing a masterbatch as claimed in one of claims 1 to 8 comprising:
(a) dissolving a powder of the polymer binder in the solvent to form a solution;
(b) mixing said solution with the carbon nanofibers and/or nanotubes and/or the carbon black, in a compounding device;
(c) kneading said mixture.

11. The process as claimed in claim 10, characterized in that the kneading is carried out via a compounding route using a co-rotating or counter-rotating twin-screw extruder or using a co-kneader.

12. A concentrated masterbatch, characterized in that it is obtained by removing all or part of the solvent from the masterbatch as claimed in any one of claims 1 to 8.

13. The concentrated masterbatch as claimed in claim 12, characterized in that it contains from 20 to 98%, preferably from 25 to 60%, or even from 40 to 60% in the case of an aqueous solvent or from 60 to 95% in the case of an organic solvent, by weight of carbon-based fillers, and advantageously a binder/carbon-based filler weight ratio of less than 2, or even of less than 1.6.

14. A process for preparing an electrode, comprising the following steps:
a) the preparation of a mixture by dispersion in a dispersion solvent of the masterbatch as claimed in one of claims 1 to 8 or 12 to 13, or obtained according to the process as claimed in either of claims 10 and 11, containing at least a first binder and optionally at least a first solvent;
b) the preparation of a solution by dissolving at least a second polymer binder in at least a second solvent;
c) the addition of an electrode active material to said solution;
d) the mixing of the products resulting from steps a) and c);
e) the deposition of the composition thus obtained on a substrate in order to form a film;
f) the drying of said film.

15. An electrode capable of being obtained according to the process as claimed in claim 14.

16. A process for preparing a composite active material for an electrode, comprising the following steps:
a) the provision of an electrode active material in the form of an aqueous solution or dispersion;
b) the addition and mixing of the masterbatch as claimed in one of claims 1 to 8 or 12 to 13, or obtained according to the process as claimed in either of claims 10 and 11, said masterbatch containing a water-soluble or water-dispersible binder, to the aqueous solution or dispersion obtained in step (a);
c) the suction-filtering and drying of the mixture obtained in step (b).

17. A composite active material for an electrode capable of being obtained according to the process as claimed in claim 16.

18. The use of the masterbatch as claimed in any one of claims 1 to 8, 12 and 13 for the preparation of liquid formulations containing carbon nanofibers and/or nanotubes and/or carbon black.
